(19) United States
(12) Patent Application Publication
(10) Pub. No.: US 2009/0066653 A1
(43) Pub. Date: Mar. 12, 2009

(54) SYSTEMS AND METHODS FOR USING A KEYBOARD AS A TOUCH PANEL

(75) Inventor: TZAN-FU WANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 12/172,262

(22) Filed: Jul. 13, 2008

(30) Foreign Application Priority Data
Sep. 10, 2007 (CN) 200710201638.1

(51) Int. Cl. G06F 3/02

(52) U.S. Cl. 345/168; 341/22

(57) ABSTRACT

A method for simulating a touch panel using a keyboard is provided. The method includes sensing a pattern of keys pressed either by sliding keystrokes or by standard keystrokes. Using the pattern of keys, a corresponding function is executed to activate one or more commands on an electronic device.

### BACKGROUND

1. Field of the Invention

Embodiments of the present disclosure relate to input devices, and more particularly to a system and a method for using a keyboard as a touch panel.

2. Description of related art

Touch panels are available in many electronic devices and provide an alternate input method for users. In using a touch panel, users are able to easily and quickly make menu selections in order to access data or activate functions of an electronic device.

Touch panels typically include a sensing unit disposed in the front of a display panel and a touch panel controller. The sensing unit is used for detecting a user's touch and the location of the touch on the display panel. When a user touches the display panel, a location of the touch is transmitted to the touch panel controller. The touch panel controller analyzes the location according to a coordinate system, and transmits the location coordinates and/or any associated function of the touch, to a central processing unit (CPU) of a device employing the touch panel. However, touch panels are typically only available in expensive devices because of a high cost of manufacturing the touch panels.

Accordingly, what is needed is a system and a method to easily and quickly access data or activate functions of an electronic device at a lower cost.

### SUMMARY

In one aspect, a method for simulating a touch panel using a keyboard is provided. The method includes the following steps: defining sliding keystrokes and standard keystrokes for one or more key presses on the keyboard, and defining a plurality of patterns of keys; sensing key events for the one or more key presses on the keyboard; generating sensing signals for the key events; converting the sensing signals into digital signals; determining a pattern of keys from the plurality of pattern of keys for the one or more key presses on the keyboard using the sliding keystrokes, wherein the determining a pattern of keys corresponds to the digital signals; and executing a function corresponding to the pattern of keys from the plurality of keys.

Other advantages and novel features of the present system and method for simulating a touch panel by using a keyboard will become more apparent from the following detailed description of exemplary embodiments when taken in conjunction with the accompanying drawings.

### BRIEF DESCRIPTION OF THE DRAWINGS

FIG. 1 is a schematic block diagram of one embodiment of a keyboard control system to control operations of a keyboard in order to employ touch commands for an electronic apparatus, such as a mobile phone;

FIG. 2 is a schematic functional block diagram of one embodiment of the keyboard control system of FIG. 1;

FIG. 3 shows several examples of key presses and their corresponding function that may be defined by a defining module;

FIG. 4 is a schematic diagram showing one embodiment of a keyboard having numbered keys arranged thereon that may be used with the keyboard control system of FIG. 1;

FIG. 5 is a schematic diagram showing one embodiment of a user menu that may be accessed using the keyboard control system of FIG. 1;

FIG. 6 is a flowchart illustrating one embodiment of a method for simulating a touch panel by using the keyboard control system of FIG. 1; and

FIG. 7 is a flowchart illustrating one embodiment of a method for determining whether a key is pressed using standard keystrokes or using sliding keystrokes.

### DETAILED DESCRIPTION OF CERTAIN INVENTIVE EMBODIMENTS

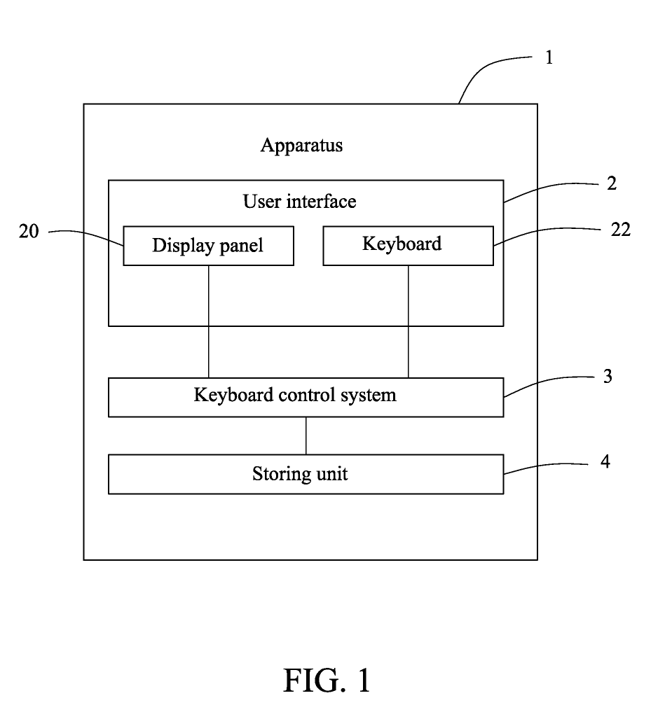

FIG. 1 is a schematic block diagram of one embodiment of a keyboard control system 3 to control operations of a keyboard in order to employ touch commands for an electronic apparatus, such as a mobile phone 1. In one embodiment, the mobile phone 1 includes a user interface 2, the keyboard control system 3, and a storing unit 4. Depending on the embodiment, the electronic apparatus may include other electronic devices, in addition to the mobile phone 1, such as notebook computers, and personal digital assistants (PDAs), for example.

The user interface 2 is configured for providing a human-machine interface for users to interact with the mobile phone 1. The user interface 2 includes a display panel 20 and a keyboard 22. The display panel 20 is configured for displaying a graphical user interface (GUI) displaying selectable items associated with various functions and/or applications of the mobile phone 1. Furthermore, the display panel 20 is configured for displaying various data, such as images, videos, results of user input etc. The keyboard 22 is an input interface for users to input commands to the mobile phone 1.

The keyboard control system 3 is configured for receiving input via standard keystrokes. Standard keystrokes means that a user may use his/her fingertip(s) to press one or more keys of the keyboard 22. The one or more keys of the keyboard 22 may be associated with a corresponding function of the mobile phone 1, and such keys are referred to as “shortcut key” hereinafter. For example, the star “*” key may be defined as a shortcut key for deleting a selected entry or multiple entries in an electronic address book of the mobile phone 1. In the above-mentioned example, when a user press the “*” key using standard keystrokes, the selected entry in the electronic address book will be deleted. If the key is not associated with a corresponding function of the mobile phone 1 and is pressed using standard keystrokes, then the digit or letter representation for which the key represents is then inputted to the mobile phone 1. In the above-mentioned example, if the start “*” key is not defined as a shortcut key, when the user press the “*” key using standard keystrokes, the letter “*” will be inputted to the mobile phone 1.

The keyboard control system 3 is further configured for receiving input in what is herein referred to as sliding keystrokes. Sliding keystrokes is where a user can slide his/her fingertip across one or more keys of the keyboard 22 in a predetermined pattern causing several keys to be depressed in a substantially quick succession. Predetermined keystroke patterns may also be associated with menu selections, data entry, and the like. Further details of sliding keystrokes will be explained herein.

The storing unit 4 may be any kind of storage, such as a flash memory, a hard disk, or any other suitable devices that can store electronic data. The storing unit 4 is configured for storing an operating system and applications together with configurations thereof, which can be recognized and processed by one or more processors embedded in the mobile phone 1. The storing unit 4 is also configured for storing various kinds of data needed for operation of the mobile phone 1.

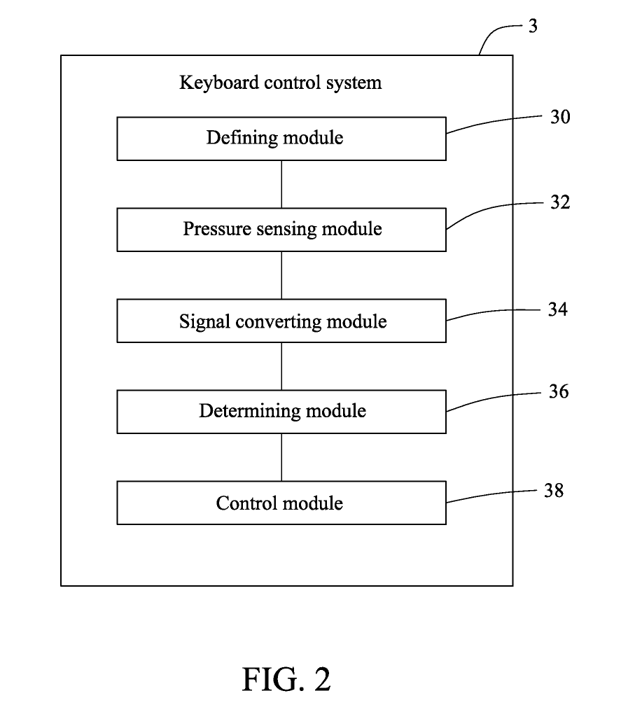

FIG. 2 is a schematic functional block diagram of one embodiment of the keyboard control system 3 of FIG. 1. In the embodiment of FIG. 2, the keyboard control system 3 includes a defining module 30, a pressure sensing module 32, a signal converting module 34, a determining module 36, and a control module 38.

The defining module 30 is configured for defining sliding keystrokes and standard keystrokes received by the keyboard 22. The defining module 30 is further configured for defining one or more keys to be pressed in one or more patterns. It may be understood that each of the patterns respectively corresponds to a defined function. The defined function and the patterns may each be defined by the defining module 30. Using the defining module 30, a user of the mobile phone 1 may define and/or customize one or more standard keystrokes or sliding keystrokes to define one or more functions. The defined functions may be used to execute operations of the mobile phone 1.

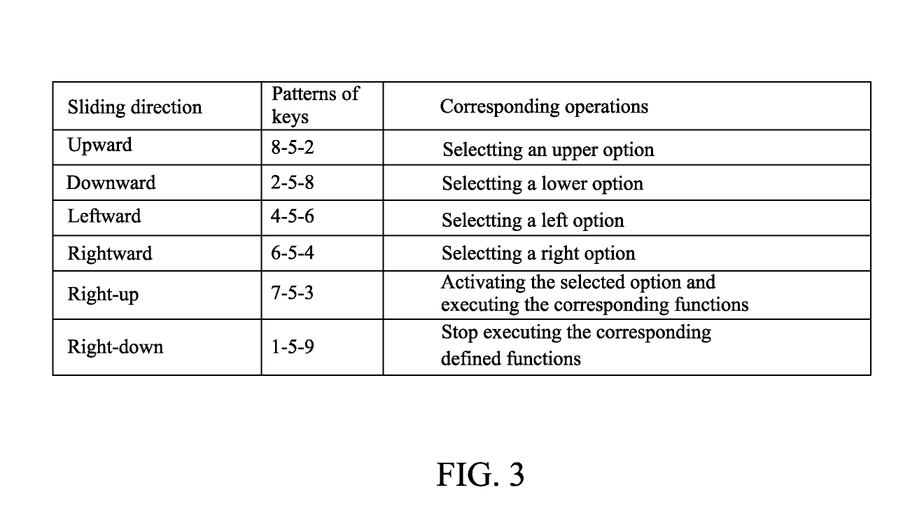

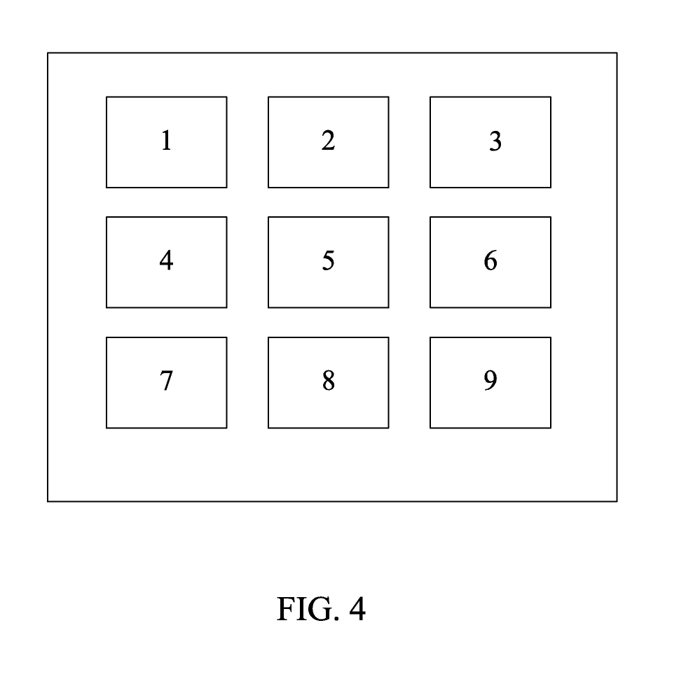

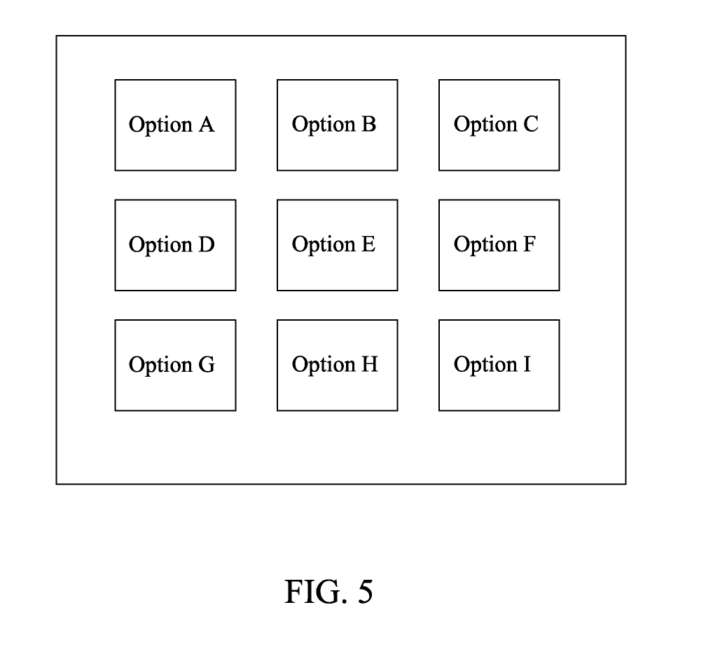

FIG. 3 shows several examples of key presses and their corresponding functions that may be defined by the defining module 30. The following examples are illustrated with the keyboard 22 having an arrangement of labeled keys as shown in FIG. 4. Also referring to FIG. 5, “Option A” through “Option I” displayed on the display panel 20 relate to different functions for a user to select in a current menu of the mobile phone 1. It may be understood that other arrangement of key presses and other functions, in addition to the ones disclosed in FIG. 3, may be defined by the defining module 30.

With regards to FIGS. 3-5 and for the purposes of illustration, several examples of key patterns are illustrated using sliding keystrokes. In one example, “option E” of FIG. 5 is selected as an initial state of the current menu of the mobile phone 1. If a user of the mobile phone 1 depresses a pattern of keys “8→5→2,” in a substantially quick succession, then a corresponding operation to the “8→5→2” pattern of keys is “selecting an upper option” as shown in FIG. 3. Thus, “option B” will be in a newly selected state after the pattern of keys “8→5→2” have been pressed. Accordingly, using “option B” as the newly selected state, the user may then depress a pattern of keys “2→5→8” in a substantially quick succession to correspond with an operation, “selecting a lower option.” Consequently, “option E” will be in the selected state. Accordingly, using “option E” as the newly selected state, the user may then depress a pattern of keys “7→5→3” in a substantially quick succession to correspond with an option, “activating a selected option and executing the corresponding function.” Therefore, “option E” will be activated and a corresponding function of “option E” will be executed. As described above, the user is capable of defining a variety of patterns of keys to execute various functions according to the user demands via the defining module 30.

The pressure sensing module 32 is disposed beneath the keyboard 22 of the keyboard control system 3 and configured for sensing key events if one or more keys on the keyboard are pressed. The key events include key press events and key release events. For a key press event, the pressure sensing module 32 includes several pressure sensitive switches corresponding to the keys of the keyboard 22. Each pressure sensitive switch includes one “pill,” where each pill comprises a generally electrically conductive material, such that if a key is pressed for a given depth, the pill is compacted to turn off a circuit. Consequently, a signal flows to the pressure sensing module 32 that determines which key was pressed. For a key release event, the pressure sensing module 32 detects whether a pill of a pressed key has been completely released. After a detection of a key event, the pressure sensing module 32 generates a sensing signal and transmits the sensing signal to the signal converting module 34. It may be understood that the sensing signals include information regarding which keys are being pressed or being released from the keyboard 22.

The signal converting module 34 is configured for converting the sensing signals into digital signals.

The determining module 36 is configured for determining whether the keys were pressed using standard keystrokes or sliding keystrokes according to the digital signals. In addition, the determining module 36 is also configured for determining whether a sequence of keys that were pressed using sliding keystrokes matches a pattern as defined in the defining module 30. Furthermore, the determining module 36 is configured for determining whether a key event includes a combination of one or more keys pressed using standard keystrokes and one or more keys pressed using sliding keystrokes.

In operation, the determining module 36 receives a digital signal indicating a first key press event. The determining module 36 continues monitoring for a pre-defined period of time after the first key press event occurs. If a time elapsed exceeds the pre-defined time (t) and no digital signal indicating a key event is received, then the first key is determined to have been pressed using a standard keystroke. If a key event is received before the pre-defined time (t), then the determining module 36 determines whether the key event relates to either a key press event or a key release event. If a digital signal indicating a key release event is received, then the first key is determined to have been pressed using a standard keystroke. Otherwise, if a digital signal indicating a key press event is received, then the first key is determined to have been pressed using a sliding keystroke. In brief, whether a first key has been pressed using a sliding keystroke can be determined by determining whether a key release event has been received before the second key has been pressed.

Upon determining that a sequence of keys have been pressed using sliding keystrokes, the determining module 36 determines whether the sequence of keys that have been pressed matches one of the pre-defined patterns of the keyboard control system 3. If the sequence of keys matches one of the pre-defined patterns, then a sensing signal indicating a pre-defined function associated with the matching pre-defined pattern is transmitted to the control module 38. If it is determined that the sequence of keys does not match any of the pre-defined patterns, then the determining module 36 determines whether any of the pressed keys matches a pattern associated with standard keystrokes. If any of the pressed keys matches a pattern associated with standard keystrokes, then a sensing signal indicating the pre-defined function associated with the pattern found is transmitted to the control module 38. If one of the pressed keys is not defined as a shortcut key, then a sensing signal indicating the digit or letter representation for which the key represents is transmitted to the control module 38.

The control module 38 is configured for receiving the sensing signal transmitted from the determining module 36, and executing one or more pre-defined functions associated with the pre-defined patterns indicated by the sensing signal. As described above, the sensing signal indicates a corresponding function to be executed and/or the digit or letter representation inputted. The control module 38 can be further configured to display a result of the user input on the display panel 20.

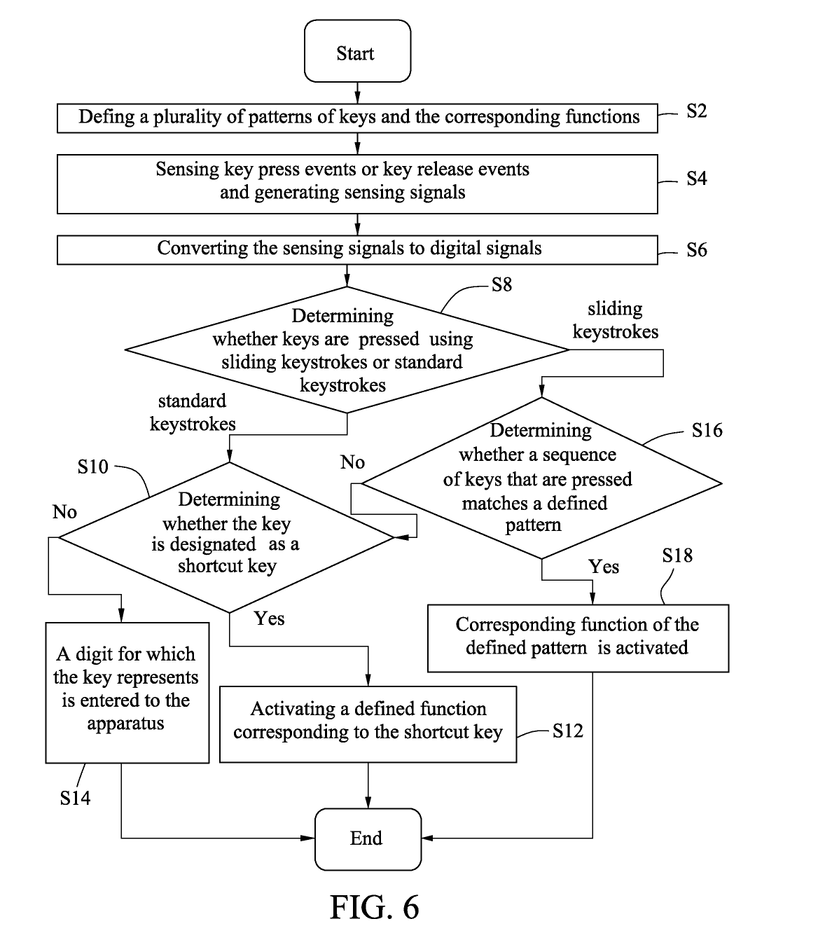

FIG. 6 is a flowchart illustrating one embodiment of a method for simulating a touch panel by using the keyboard 22. The flowchart of FIG. 6 may be used to sense one or more keystrokes on the keyboard 22 and translate the keystrokes into executable commands in order to control operations of the mobile phone 1. Depending on the embodiment, additional blocks may be added or deleted and the blocks may be executed in a different order than described.

In block S2, the defining module 30 defines one or more sliding keystrokes and standard keystrokes corresponding to a pre-defined pattern and the corresponding function thereof. In block S4, the pressure sensing module 32 senses a key press event or a key release event and transmits the sensing signal to the signal converting module 34. In block S6, the signal converting module 34 coverts the sensing signal into a digital signal.

In block S8, the determining module 36 determines whether a key event uses sliding keystrokes or standard keystrokes according to the digital signal. In block S10, if the key event uses the standard keystrokes, then the determining module 36 further determines whether the key is designated as a shortcut key. If the key is designated as a shortcut key, in block S12, a pre-defined function corresponding to the shortcut key is executed by the control module 38. After the defined function is executed, in block S20, the pressure sensing module 32 continues monitoring for a next key event.

If the key is not designated as a shortcut key in block S10, a digit or letter representation for which the key indicates is entered to the mobile phone 1 and displayed on the display panel 20 by the control module 38 in block S14. Afterwards, when the user presses additional keys on the keyboard 22, the process will start from block S4 so as to continuously monitor the key events.

If the key is pressed using sliding keystrokes in block S8, then the process goes directly to block S16 for determining whether a sequence of the keys that are pressed matches one of the pre-defined patterns of keys. If the sequence of the keys that have been pressed does not match one of the pre-defined pattern of keys, then the process goes to block S10 for further determining whether the pressed keys are designated as shortcut keys.

If the sequence of the keys that are pressed matches one of the pre-defined pattern of keys, in block S18, a defined function corresponding to the defined pattern of keys is activated by the control module 38. Afterwards, when the user presses additional keys on the keyboard, the process will start from block S4 so as to continuously monitor the key events.

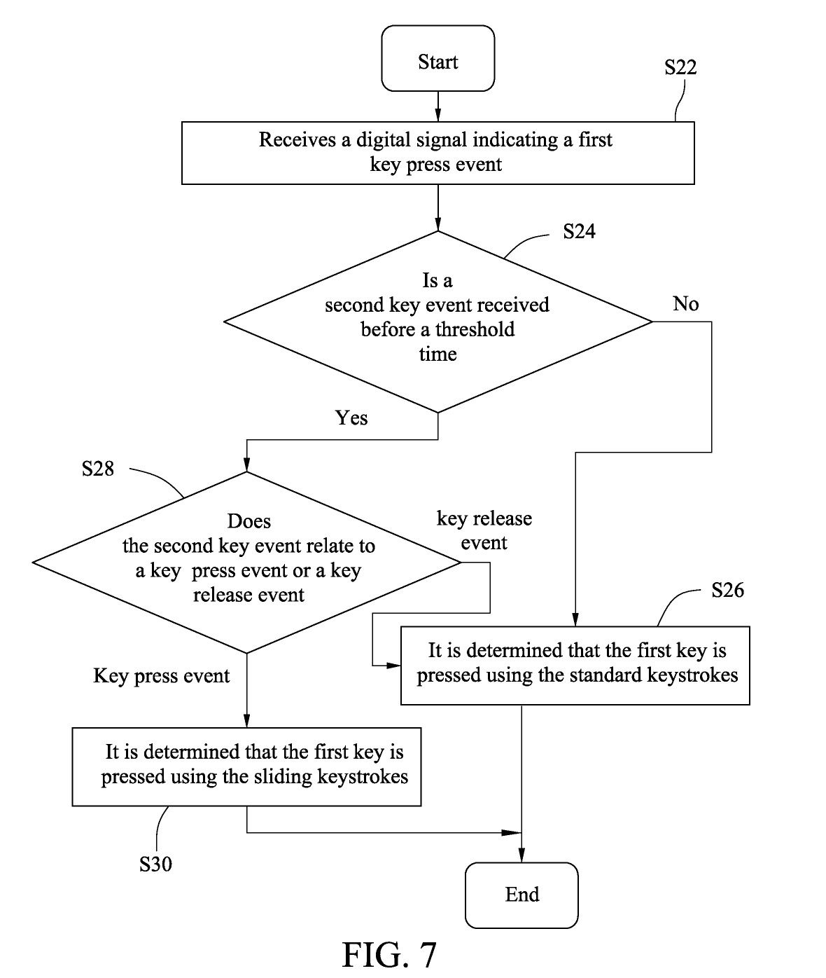

FIG. 7 is a flowchart illustrating one embodiment of a method for determining whether a key is pressed using standard keystrokes or using sliding keystrokes. In block S22, the determining module 36 receives a first digital signal indicating a first key press event. In block S24, the determining module 36 determines whether a second digital signal indicating a second key event has been received in a pre-determined threshold time.

If the digital signal indicating a second key event is received in the predetermined threshold time, then the determining module 36 determines whether the second key event relates either to a key press event or a key release event in block S28. If the second key event relates to the key press event, then in block S30, then the first key event is determined to be pressed using sliding keystrokes. If the second key event relates to the key release event, then the first key event is determined to be pressed using standard keystrokes in block S26.

If the second digital signal indicating the second key event is not received in the pre-determined threshold time, then the first key event is determined to be pressed using standard keystrokes in block S26.

It should be emphasized that the above-described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. A system for simulating a touch panel using a keyboard, the system comprising:
a defining module configured for defining one or more sliding keystrokes and one or more standard keystrokes for one or more key presses on the keyboard, and further configured for defining one or more patterns of keys to be pressed using sliding keystrokes;
a pressure sensing module configured for sensing a key event for the one or more key presses on the keyboard, and further configured for generating a sensing signal corresponding to the one or more key presses;
a signal converting module configured for converting the sensing signal into a digital signal;
a determining module configured for determining a pattern of keys from the one or more pattern of keys that matches the one or more key presses using the one or more sliding keystrokes; and
a control module configured for executing one or more defined functions corresponding to the pattern of keys from the one or more pattern of keys.

2. The system as claimed in claim 1, wherein the pressure sensing module is disposed beneath the keyboard for sensing the key event, wherein the key event comprises a key press event and a key release event.

3. The system as claimed in claim 1, wherein the determining module is further configured for determining if a first key has been pressed using the sliding keystrokes upon the condition that a second key has been pressed before the first key has been released, wherein the first key and the second key are from the one or more key presses on the keyboard.

4. The system as claimed in claim 1, wherein the determining module is further configured for determining if a first key has been pressed using the standard keystrokes upon the condition that the first key has been released before a second key has been pressed.

5. The system as claimed in claim 4, wherein the defining module is further configured for defining a plurality of shortcut keys to be pressed using the standard keystrokes, wherein each of the plurality of shortcut keys correspond to a defined function.

6. The system as claimed in claim 5, wherein the determining module is further configured for determining whether the one or more key presses on the keyboard using the standard keystrokes corresponds to at least one of the plurality of shortcut keys.

7. The system as claimed in claim 5, wherein the control module executes the defined function corresponding to at least one of the plurality of shortcut keys upon the condition that the one or more key presses using the standard keystrokes corresponding to at least one of the plurality of shortcut keys.

8. A method for simulating a touch panel using a keyboard, comprising:
defining sliding keystrokes and standard keystrokes for one or more key presses on the keyboard, and defining a plurality of patterns of keys;
sensing key events for the one or more key presses on the keyboard;
generating sensing signals for the key events;
converting the sensing signals into digital signals;
determining a pattern of keys from the plurality of pattern of keys for the one or more key presses on the keyboard using the sliding keystrokes, wherein the determining a pattern of keys corresponds to the digital signals; and
executing a function corresponding to the pattern of keys from the plurality of keys.

9. The method as claimed in claim 8, wherein the key events comprises key press events and key release events.

10. The method as claimed in claim 8, wherein the determining block comprises:
determining if a first key has been pressed using the sliding keystrokes upon the condition that the first key has been released before a second key has been pressed.

11. The method as claimed in claim 8, wherein the determining block further comprises:
determining if a first key has been pressed using the sliding keystrokes upon the condition that the first key has been released before a second key has been pressed.

12. The method as claimed in claim 8, wherein the defining block comprises:
defining a plurality of shortcut keys to be pressed using the standard keystrokes, wherein each of the plurality of shortcut keys correspond to a defined function.

13. The method as claimed in claim 12, wherein the defining block further comprises:
determining whether the one or more key presses using the standard keystrokes is designated as a shortcut key.

14. The method as claimed in claim 13, wherein the defining block further comprises: executing the defined function corresponding to the shortcut key if the one or more key presses use the standard keystrokes.

15. A computer-readable medium having stored thereon instructions that, when executed by an electronic device, cause the electronic device to:
define sliding keystrokes and standard keystrokes for one or more key presses on the keyboard, and define a plurality of patterns of keys;
sense key events for the one or more key presses on the keyboard;
generate sensing signals for the key events;
convert the sensing signals into digital signals;
determine a pattern of keys from the plurality of pattern of keys for the one or more key presses on the keyboard using the sliding keystrokes, wherein the determining a pattern of keys corresponds to the digital signals; and
execute a function corresponding to the pattern of keys from the plurality of keys.

16. The computer-readable medium as claimed in claim 15, wherein the key events comprises key press events and key release events.

17. The computer-readable medium as claimed in claim 15, wherein the determine block comprises:
determine if a first key has been pressed using the sliding keystrokes upon the condition that the first key has been released before a second key has been pressed.

18. The computer-readable medium as claimed in claim 15, wherein the determine block further comprises:
determine if a first key has been pressed using the sliding keystrokes upon the condition that the first key has been released before a second key has been pressed.

19. The computer-readable medium as claimed in claim 15, wherein the defining block comprises:
define a plurality of shortcut keys to be pressed using the standard keystrokes, wherein each of the plurality of shortcut keys correspond to a defined function.
